(19) United States
(12) Patent Application Publication
(10) Pub. No.: US 2006/0239512 A1
(43) Pub. Date: Oct. 26, 2006

(54) Anti-identity theft system and method

(75) Inventor: Susan R. Petrillo, Ocala, FL (US)

Correspondence Address: SILLS CUMMIS EPSTEIN & GROSS P.C., ONE RIVERFRONT PLAZA, IP DEPARTMENT, NEWARK, NJ, 07102, US

(73) Assignee: IMMe, LLC

(21) Appl. No.: 11/165,966

(22) Filed: Jun. 24, 2005

Related U.S. Application Data
(60) Provisional application No. 60/674,017, filed on Apr. 22, 2005.

(51) Int. Cl. G05B 19/00; G06K 9/00; H04K 1/00

(52) U.S. Cl. 382/115; 382/124; 902/3; 713/186; 340/5.82

(57) ABSTRACT

A method of entering information for identity validation of an individual is provided, where an individual enters their personal information and biometric information that is compared to one or more databases to verify the identity of the individual. Once the identity is verified, the individual selects one or more random biometrics that are stored as random biometric information on a database for later identity verification purposes. When the individual later wants to review or change his personal information, or when the individual wants to perform or consummate a transaction, the individual simply submits his/her one or more random biometrics that were previously selected and stored in the database. The biometrics are compared with the random biometric information in the database, and if the one or more random biometrics match the random biometric information in the database, then the identity is verified.

This application claims the benefit of provisional application No. 60/674,017, filed on Apr. 22, 2005, the contents of which are incorporated herein by this reference.

### BACKGROUND OF THE INVENTION

1. Field of the Invention

The present invention relates to identity verification systems of individuals, and more specifically, to identity verification systems of individuals using certain random biometric information of the individuals.

2. Prior Art

Identity theft is defined by an individual (criminal) who impersonates another individual (victim) for the purpose of obtaining a financial benefit (credit, loans, money, benefits, etc.) unbeknownst to the victim. Statistics show that identity theft is a major concern among consumers today. According to a survey conducted by Ipsos-insights in January 2004, 76% of consumers had major or moderate concern about credit card security and 69% of consumers had major/moderator concern about online credit card security.

According to a study by the Federal Trade Commission conducted in August 2003, there were 9.9 million victims in 2002 of new and existing credit card fraud and other types of account fraud. U.S. credit card fraud cost consumers and customers 2.66 billion dollars in 2004 and is estimated to cost consumers and companies 3.21 billion dollars by 2007, according to Celent Communications.

As per the Federal Trade Commission, the statistics on reasons given for Identity Theft are:

53% to obtain/take over a credit card account;

27% to acquire telecommunication services;

17% to obtain/take over a checking account; and

11% to obtain a loan.

An individual may try to use fraudulent identification to open credit accounts. As with banks, to apply for credit accounts, an individual typically needs a photo form of identification and in some cases, an additional form of identification such as a social security card. However, both photo identification and social security cards can be easily manipulated using digital editing software and a printer.

The problems with fraudulent identification originate from the fact that current forms of identification are too prone to manipulation because of advancing technology. To combat evolving digital imaging technology, new security measures are being employed with photo identification such as holograms. While improvements to photo identification may prove helpful, more needs to be done to prevent identity theft and fraudulent identification.

Old methods of collecting and disbursing personal credit information required credit reporting agencies to gather and disburse information about individuals and companies, and to disburse this information to entities that request such information. In general, such disbursement is performed after an individual authorizes the release of such information. While these companies gather credit information from several sources, they often provide incomplete or inaccurate information that is not verified by the user until a later date.

One method to prevent identity theft and fraudulent identification is to use biometric information to identify individuals. Biometric information, such as fingerprints, is a nearly infallible means of personal identification that is not easily falsified. Fingerprints do not change with time and are unique to each individual.

Biometric Authentication technology has the potential of providing the necessary level of identity integrity, if adequate control is placed over the points of enrollment and a post enrollment system is also implemented. Without such control, biometrics will merely validate that the identity claimed by an individual who seeks to be authenticated is the same identity as was claimed by applicant and associated with their presented biometric at the time of enrollment, whether fraudulent or not. What biometric technology will not do is reveal whether an individual being authenticated actually owns the identity they claim.

Therefore, there remains a need for an efficient system and method for identifying individuals to prevent identity fraud related to banking and credit transactions that is capable of identifying individuals at any location. Further, there exists a need for a biometric database that validates the true ownership by an individual of a claimed identity that ensures the individual being authenticated owns the claimed identity.

### SUMMARY OF THE INVENTION

Therefore, it is an object of the present invention to provide an identity verification system that is capable of identifying if a claimed identity is an individual's actual identity, by using the individual's biometric information, and ensuring that it is that individual's biometric information.

The present invention provides for a repository/database that stores biometric information on individuals. Whenever an individual applies for a financial benefit, the individual must present this same biometric information for validation and positive confirmation.

The identity verification system is divided into two procedures. The objective of the first process of the proposed system is to significantly reduce or eliminate identity theft by confirming the identity of the individual.

The objective of the second process is to significantly reduce or eliminate credit/debit card theft, benefit fraud, etc. by using biometrics and by eliminating the need for identification cards for every financial institution, e.g. credit cards, debit cards, etc.

Accordingly, a method of entering information for identity validation of an individual is provided, the method comprising collecting biometric information of an individual, storing the biometric information of the individual, and storing one or more random biometrics selected by the individual from the biometric information stored for identity verification purposes.

The method of entering information for identity validation of an individual further comprises verifying the individual's biometric information by using positive and negative validation. The one or more random biometrics can comprise fingerprint information. The method further comprises collecting and storing personal information of the individual, and verifying the individual's personal information by using positive and negative validation.

The method of entering information for identity validation of an individual of claim 1, further comprises storing two or more random biometrics selected by the individual from the biometric information stored for identity verification purposes, where the two or more random biometrics can comprise two randomly selected fingerprints.

Further, a method of entering information for identity validation of an individual is provided, the method comprising collecting personal information of an individual, collecting biometric information of an individual, verifying the identity of the individual by matching the personal information and biometric information to databases storing the personal information and biometric information, storing the personal and biometric information of the individual if the identity is verified, and storing one or more random biometrics selected by the individual from the biometric information for identity verification purposes.

Additionally, a method of validating an identity of an individual is provided, the method comprising accepting one or more random biometrics submitted by an individual, comparing the one or more random biometrics to a database storing biometric information of the individual and the one or more random biometrics of the individual, and verifying the identity of the individual if the submitted one or more random biometrics submitted by the individual match the one or more random biometrics stored in the database. The one or more random biometrics can comprise fingerprint information.

The method of validating an identity of an individual further comprises comparing two or more random biometrics to the database storing biometric information of the individual and the two or more random biometrics of the individual, and verifying the identity of the individual if the submitted two or more random biometrics submitted by the individual match the two or more random biometrics stored in the database.

The method of validating an identity of an individual further comprises allowing the individual access to the individual's personal records if the identity of the individual is verified. The method further comprises allowing the individual to make a purchase or transaction if the identity of the individual is verified, and alerting appropriate authorities if the individual's identity is not verified.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematic representation of an initial identity verification system for registration to the database of the present invention.

FIG. 2 illustrates a schematic representation of the identity verification system after registration for access to the database of the present invention.

FIG. 3 illustrates a schematic representation of an identity verification process when an individual performs a transaction in accordance with the present invention.

### DETAILED DESCRIPTION OF THE INVENTION

Although this invention is applicable to numerous and various types of identity verification systems of individuals, it has been found particularly useful in the environment of identity verification systems that store biometric information of the individuals. Therefore, without limiting the applicability of the invention to the above, the invention will be described in such environment.

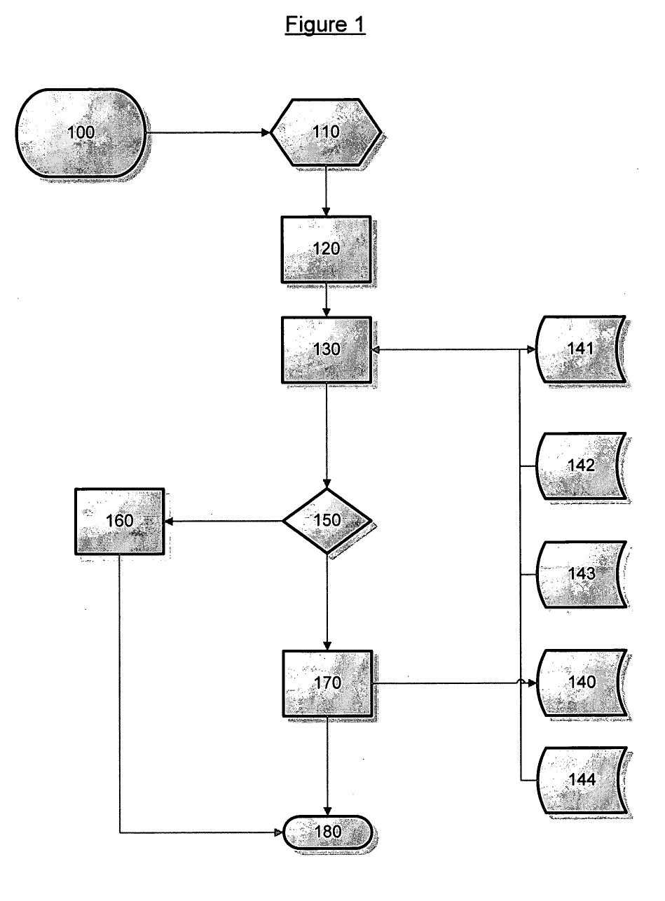

With reference to FIG. 1, an initial registration system for an individual to a database 140 of the identity verification system according to the present invention will be described. Initially, at step 100, an individual (applicant) will make a request to register their information on the database 140 of the present invention. An individual can be one person such as an applicant, an association of individuals, a business, an organization, or other type of entity that utilizes the present invention. For example, an individual user can be a consumer in transactions undertaken with the present invention. An association of individuals, who together form a user, can be members of a particular service provider or merchant organization that provide services or products to the public (e.g., vendors). A financial institution providing, moving or storing funds or credit for a transaction can be a bank or merchant.

The request at step 100 can therefore be made by the individual themselves, or by a financial institution, government agency, private organization, company, etc., on behalf of the individual. At step 110, a verification of the request is made, such as if all the appropriate initial information has been received from the individual at step 100.

When the individual requests inclusion on the database 140 of the present invention, the applicant's identity must be confirmed after the verification request 110. At step 120, the applicant submits proof of his/her identity by submitting the applicant's personal information. Such personal information can include all or some of the following: name, address, social security number, birth date, citizenship, race, photo, employer information, parents, spouse, offspring, personal preferences, etc. Further, at step 120, the applicant submits certain biometric information, such as a complete set of finger prints, retina scan, samples of speech, DNA sequences, hair samples, and/or other biometric information known to one of ordinary skill in the art.

At step 130, the applicant's information is confirmed/verified by using a system of both positive and negative validation. All of the information submitted by the applicant is verified at step 130 by the system of positive and negative validation.

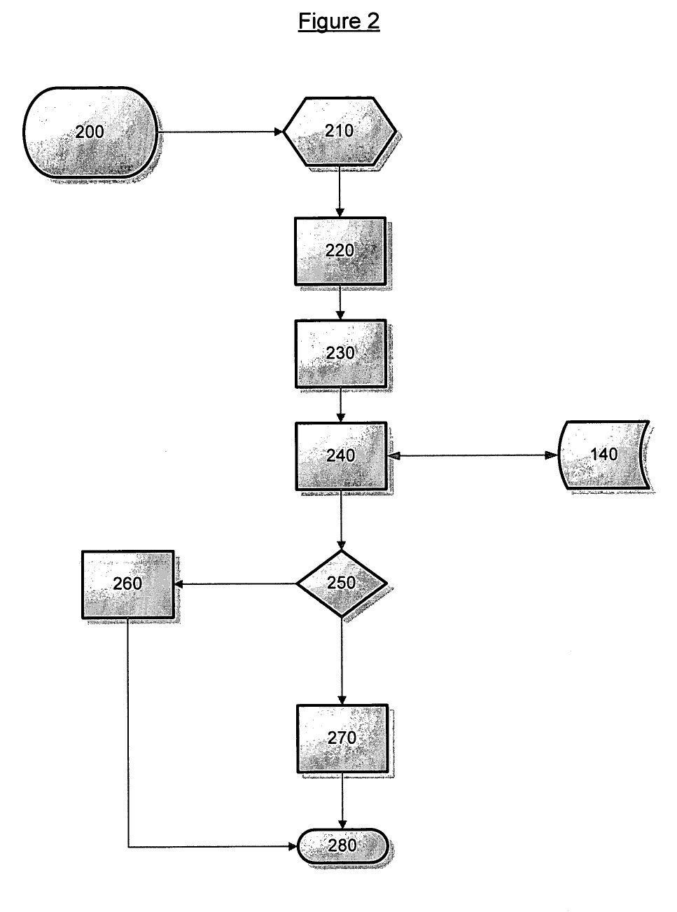

The positive validation can include verifying the individual's information by comparing the submitted information to credit reporting agency databases 142, biometric information storing databases 143, and/or other databases 144, such as government databases or other public/private databases that may store the personal information of the individual. Additionally, the system checks for duplicate applications on the database 140 of the present invention to prevent and detect possible identity theft. The applicant's information is compared to information stored in the database 140, to ensure that the applicant has not already registered previously. If so, the request to register can be denied, and the individual can be notified that he/she has already been registered in the database 140 of the present invention. The individual can then be requested to access the identity verification system of FIG. 2 for applicants that have already registered, which will be further explained below.

The positive validation can include a system similar to the New Jersey Motor Vehicle Commission's “6-Point” Verification System to verify the applicant's identity, as provided on the website: http://www.state.nj.us/mvc/ident_ver_posterpint.pdf. This “6-Point” Verification System includes procedures for both U.S. and non U.S. citizens. Acceptable forms of identity can include a passport, driver's license, social security card, various government documents (military/government agencies), bank statements showing current address, credit card or utility bills showing current address, photo I.D. cards, etc.

In addition to the positive validation of an individual, the system performs negative validation such as multiple negative screening procedures. Here, the personal (name, address, etc.) and biometric (fingerprints, DNA, etc.) information submitted by the applicant is cross checked with databases 141 of various law enforcement and government agencies for criminal activity (including fraud, larceny, etc) to flag known convicted criminals. For example, the applicant's information can be compared to a database such as the Integrated Automated Fingerprint Identification System (IAFIS), a national fingerprint and criminal history system maintained by the Federal Bureau of Investigation (FBI). The IAFIS provides automated fingerprint search capabilities, latent searching capability, electronic image storage, and electronic exchange of fingerprints and responses, and is further described on the website: http://www.fbi.gov/hq/cjisd/iafis.htm. Further, the applicant's photo can be compared against known criminals and existing registrants using a facial recognition system.

At step 150, if the identity of the individual is not verified after comparison to one or more of the databases 140-144, the system proceeds to step 160, where the system informs that individual that the request has been denied, and the process ends 180. Alternatively, if any criminal activity is detected during the verification process, the appropriate authorities can be contacted at step 160. If the identity of the applicant is verified at step 150, then all of the applicant's information submitted (personal and biometric) is stored in the database 140 of the present invention at step 170.

Further, at step 170, the applicant is requested to select two random biometrics of their choice out of the biometric information submitted at step 120, that will be used for purposes of verification, as will be further described below. Two random biometrics can consist of any two biometrics submitted based on the individual's choice. For example, the two random biometrics can be one fingerprint and a retina scan, a retina scan and a speech sample, etc. Preferably, the two random biometrics consist of two random fingerprints of the individual, where the two fingers selected can be both from one hand, or one from each hand (e.g., a pinkie and thumb). The two random biometrics selected are stored in the database 140. After this information is selected and stored, the applicant is registered and is informed of the registration, and the process ends 180.

By submitting two random biometrics, such as two random finger prints, the chance of fraud is significantly reduced since the exact two biometrics, such as finger prints, submitted must be known. The probability of another individual correctly guessing which two biometrics were randomly submitted is significantly low. For example, the chances of correctly guessing which two fingerprints were selected by an individual is 0.02 or two percent, as there are 45 possible combinations of two fingers. The invention is not limited to an embodiment of two random biometrics, and, of course, for less chance of fraud, three, four, or even more random biometrics can be chosen by the individual. The system is not limited to two random biometrics, but two are chosen in the particular embodiment described. If desired, even one random biometric can be chosen, although the chances of correctly guessing which biometric is used would then increase.

FIG. 2 illustrates the identity verification system according to the present invention once the individual is already registered to the database 140 of the present invention. At step 200, the individual requests access to his/her information, to either make a change to the information (such as address, phone number, etc.), or to review the information. The request is made at step 210 to the system of the present invention, or to any other organization's computer system that is compatible with that of the present invention.

To confirm the individual's identity, at step 220, the individual is requested to submit the same two random biometrics selected in the system of FIG. 1 (step 170). Other initial information can be requested from the individual prior to or after this request (such as name, address, etc.), in order to ensure higher levels of security. The system of the present invention or any other computer compatible with that of the present invention then forwards this request to the present invention for validation at step 230.

At step 240, the present invention processes the request, and the two random biometrics submitted by the individual are compared to the records stored in the database 140 of the present invention. At step 250, if the identity is validated (i.e., the submitted two random biometrics of the individual match with the stored two random biometrics in the database 140), then the request is approved at step 270, and the individual is allowed to access his/her records and make changes and/or view the records. Once the individual has completed the transactions desired, the process ends 280.

If the identity is not validated at step 250 (i.e., the submitted two random biometrics of the individual do not match with the stored two random biometrics in the database 140), the request is denied, and/or appropriate authorities can be contacted, and the process ends 280. The system can be programmed to give the individual one or more attempts, but preferably not more than one attempt, in case of an inadvertent error in submitting the two biometrics. More preferably, the individual is given one attempt, and more personal information is required to be entered by the individual (e.g. current address, last four numbers of social security number, data of birth, a third biometric, etc.) during the second attempt if the first attempt was incorrect or was denied.

The identity verification process can have broad appeal to individuals and companies world wide. This validation process can be offered to individuals who voluntarily apply to prevent their own identity theft, government agencies that require individuals to be on file to reduce or eliminate benefit fraud and security issues, financial institutions (offering credit) that require individuals to be on file thereby offering this benefit to the individuals and thereby reducing their identity theft losses, and several other similar interested entities.

If the financial institution or government agency requires biometric validation of the individual, they will submit the biometric information whenever the individual applies for credit or attempts to update their credit information. If the individual is not already in the database, then the financial institution or government agency will submit the individual for inclusion in the database.

If the individual has requested to be on the database 140, then anytime a credit application is submitted or attempts to update or change any information in their financial record, the financial institution receiving the credit application/request must obtain biometric validation of the applicant's identity. The individual's request to authenticate their identity can be accomplished by placing the validation requirement on their credit record which is stored by any of the following three credit agencies: Equifax®, Experian®, and Trans Union®. In addition, any profile updates (e.g. address, phone number, etc.) to either the validation authority or the entity issuing credit would also require biometric validation (this would require the credit agencies to agree to use our system to validate the individual before they can make updates in the records of the credit agencies).

A major objective is to try to be sure that the validation authority (the database 140 and system of the present invention) is not “owned” or “operated” by any one financial institution. A major advantage would be if all financial institutions could utilize the service and an individual's biometric information would be stored only in one database.

The validation authority can exist as an independent agency of which financial institutions, credit reporting companies and government agencies subscribe to, a cooperative of financial institutions that credit reporting and government agencies belong to, a government-based agency of which financial institutions and reporting agencies subscribe to, an independent agency of which credit companies and/or banks subscribe to and the credit reporting agencies act as only a fraud alert mechanism, or financial institutions and/or credit reporting agencies that maintain their own separate validation systems for their own use or which the credit companies and or banks subscribe to.

If each agency keeps its own set of biometric information, then the chance for this information to be obtained by the “wrong individuals” is greatly increased. Keeping the information in one location where it can be utilized but never obtained by any organization or institution reduces the opportunity for theft and fraud. Also, by keeping this information in the private sector, it removes objections from individuals concerned that the government is obtaining too much personal information.

The present identity verification system provides several advantages that solve the problems with prior art methods. Unlike other organizations, the personal information contained in the database of the present invention will never be sold or distributed without the expressed consent of the individual. The information will be used for identity verification purposes only. The random two biometrics submitted ensures that only the individual knows which two biometrics were selected out of the all of the biometric information that was submitted, which significantly decreases the chances of fraud and identity theft.

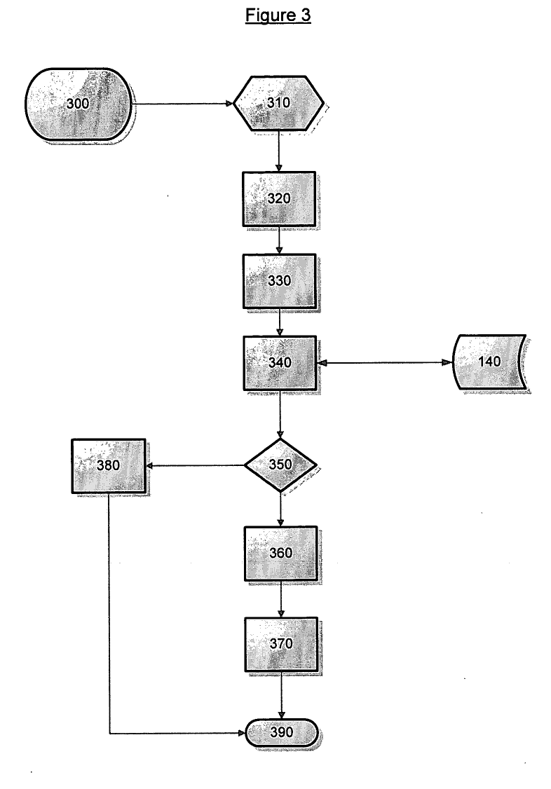

FIG. 3 provides for an identity verification process when the individual wants to perform a transaction (e.g., use a credit card or debit card for a purchase). At step 300, an individual that has already stored his/her information in the database 140 of the present invention initiates a transaction at an agency or a merchant by using his/her credit or debit card. Such use can be for a credit/debit purchase, or to withdraw money at an ATM. At step 310, an identification validation request is made. At step 320, the individual submits one or two of the randomly chosen biometrics that were stored in the database 140. A third random biometric can also be submitted as the database stores several biometrics of the individual. The organization, agency, or machine where the transaction is initiated forwards this information at step 330 and request identity validation.

At step 340, the identity validation request is received and processed. Utilizing the existing financial networks (e.g., CIRRUS®, PLUS®, etc.), the identity validation request is routed to the database 140 for identity validation. At step 350, the identity of the individual is validated. If the biometric(s) submitted matches the information of the individual stored in the database, then at step 360 the request is approved, and at step 370, the approval is forwarded to the requesting agency for authorization. The transaction is routed through the same network (and same procedures which exist today) to the appropriate financial institution or agency for standard credit authorization, and the process ends 390.

If the biometric(s) submitted does not match the information of the individual stored in the database, then the identity validation request is denied, the appropriate agencies can be contacted, and the process ends 390.

During the initial transition period, when the present invention is first offered to merchants and agencies, organizations offering credit would have to have both the existing credit equipment as well as a biometric information processor. Eventually, the need for any credit or identification cards may be totally eliminated as the biometric system would identify the individual.

The credit/debit account number and routing information could be stored in the database 140. The individual making a debit/credit transaction would submit their “purchase” biometric(s), and select their financial organization (Master Card®, Visa®, American Express®, etc.). The transaction would travel through the existing financial networks to the system of the present invention and the database 140 where the individual's identity is validated. Once validated, the appropriate financial institution routing information is appended to the transaction and sent to the financial institution for credit authorization. Credit authorization would still be conducted by the appropriate financial institution or agency. A similar system could be employed for ATM withdrawals.

In 2003, the financial networks handled 16 billion credit transactions and 15 billion debit transactions (Nilson Report, April 2003). The potential benefits of having such a system include the elimination of credit/identity cards, and significant consumer savings, financial institutions savings, and government agency savings due to reduced fraud.

The above descriptions of the present invention are specific embodiments of the present invention and are not limited to the above descriptions and uses. Various other uses are also possible, in which the present invention can be implemented by any form of applicable technology, including but not limited to the following computer and circuitry types: electrical, digital, analog, optical, magnetic, mechanical, or any combination thereof. In addition, the system chosen to implement the invention can be general purpose, embedded, portable, networked, client/server, web server, database server, wireless or any combination thereof. In addition, user input can be obtained through various means including but not limited to keyboard, computer mouse, punch cards and speech recognition. Biometric information can be input through various means including, but not limited to fingerprint scanners, retinal scanners, voice scanners, video cameras, microphones, or any other scanners. Output devices include, but are not limited to cathode ray tube, light emitting diode, liquid crystal display, vacuum, fluorescent or plasma displays, speech synthesis, printers and plotters.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method of entering information for identity validation of an individual, the method comprising:
collecting biometric information of an individual;
storing the biometric information of the individual; and
storing one or more random biometrics selected by the individual from the biometric information stored for identity verification purposes.

2. The method of entering information for identity validation of an individual of claim 1, further comprising:
verifying the individual's biometric information by using positive validation.

3. The method of entering information for identity validation of an individual of claim 1, further comprising:
verifying the individual's biometric information by using negative validation.

4. The method of entering information for identity validation of an individual of claim 1, further comprising:
collecting and storing personal information of the individual.

5. The method of entering information for identity validation of an individual of claim 4, further comprising:
verifying the individual's personal information by using positive validation.

6. The method of entering information for identity validation of an individual of claim 4, further comprising:
verifying the individual's personal information by using negative validation.

7. The method of entering information for identity validation of an individual of claim 1, further comprising:
storing two or more random biometrics selected by the individual from the biometric information stored for identity verification purposes.

8. The method of entering information for identity validation of an individual of claim 7, wherein the two or more random biometrics comprise two randomly selected fingerprints.

9. The method of entering information for identity validation of an individual of claim 1, wherein the one or more random biometrics comprise fingerprint information.

10. A method of entering information for identity validation of an individual, the method comprising:
collecting personal information of an individual;
collecting biometric information of an individual;
verifying the identity of the individual by matching the personal information and biometric information to databases storing the personal information and biometric information;
storing the personal and biometric information of the individual if the identity is verified; and
storing one or more random biometrics selected by the individual from the biometric information for identity verification purposes.

11. The method of entering information for identity validation of an individual of claim 10, the method further comprising:
verifying the individual's biometric information by using positive validation.

12. The method of entering information for identity validation of an individual of claim 10, the method further comprising:
verifying the individual's biometric information by using negative validation.

13. The method of entering information for identity validation of an individual of claim 10, the method further comprising:
verifying the individual's personal information by using positive validation.

14. The method of entering information for identity validation of an individual of claim 10, the method further comprising:
verifying the individual's personal information by using negative validation.

15. The method of entering information for identity validation of an individual of claim 10, the method further comprising:
storing two or more random biometrics selected by the individual from the biometric information stored for identity verification purposes.

16. The method of entering information for identity validation of an individual of claim 15, wherein the two or more random biometrics comprise two randomly selected fingerprints.

17. The method of entering information for identity validation of an individual of claim 10, wherein the one or more random biometrics comprise fingerprint information.

18. A method of validating an identity of an individual, the method comprising:
accepting one or more random biometrics submitted by an individual;
comparing the one or more random biometrics to a database storing biometric information of the individual and the one or more random biometrics of the individual; and
verifying the identity of the individual if the submitted one or more random biometrics submitted by the individual match the one or more random biometrics stored in the database.

19. The method of validating an identity of an individual of claim 18, wherein the one or more random biometrics comprise fingerprint information.

20. The method of validating an identity of an individual of claim 18, the method further comprising:
comparing two or more random biometrics to the database storing biometric information of the individual and the two or more random biometrics of the individual; and
verifying the identity of the individual if the submitted two or more random biometrics submitted by the individual match the two or more random biometrics stored in the database.

21. The method of validating an identity of an individual of claim 20, wherein the two or more random biometrics comprise two randomly selected fingerprints.

22. The method of validating an identity of an individual of claim 18, the method further comprising:
allowing the individual access to the individual's personal records if the identity of the individual is verified.

23. The method of validating an identity of an individual of claim 18, the method further comprising:
allowing the individual to make a purchase or transaction if the identity of the individual is verified.

24. The method of validating an identity of an individual of claim 18, the method further comprising:
alerting appropriate authorities if the individual's identity is not verified.
